(19) United States
(12) Patent Application Publication
(10) Pub. No.: US 2015/0019653 A1
(43) Pub. Date: Jan. 15, 2015

(54) METHOD AND SYSTEM FOR ADDING AN IDENTIFIER

(71) Applicant: CIVOLUTION B.V., Eindhoven (NL)

(72) Inventor: Alex Dick Terpstra, Eindhoven (NL)

(73) Assignee: CIVOLUTION B.V., Eindhoven (NL)

(21) Appl. No.: 13/941,949

(22) Filed: Jul. 15, 2013

(51) Int. Cl. H04L 12/58

(52) U.S. Cl. CPC H04L 51/063; H04L 51/32
USPC 709/206; 709/219

(57) ABSTRACT

A computer-implemented method of automatically adding an identifier related to a content item to a communication in a multi-user communication network such as a social network. The method comprising obtaining a robust fingerprint of the content item, retrieving the identifier from a database using the robust fingerprint, and adding the identifier formatted in a format suitable for the multi-user communication network to the communication. Preferably the robust fingerprint relates to a particular timepoint in the content item and the identifier relates to an aspect of the content item at the particular timepoint. Also a system and computer program product.

### FIELD OF THE INVENTION

The invention relates to a computer-implemented method of adding an identifier related to a content item to a communication in a multi-user communication network such as a social network.

The invention further relates to a computer system for rendering a content item.

The invention further relates to a computer program product.

### BACKGROUND OF THE INVENTION

A social networking service is a platform to build social networks or social relations among people who, for example, share interests, activities, backgrounds, or real-life connections. In technical terms, social networks provide the means to communicate in a multi-user communication network where users of the network are somehow connected or related in one or more social aspects. One may have friends, followers, or buddies that read messages. Typically messages are sent to all these recipients, although a subset of users can also be made.

Interaction is key in such a network. To facilitate structured communication and interaction, messages in a social network can be categorized, tagged or labeled in some way to allow selection based on topic, interest or other criterion. For example, the tumblr social network allows categories and tags to be assigned to posts. Twitter famously employs hashtags, short phrases preceded by the pound or hash character (#), allowing users to select only messages using these tags.

The social networks Facebook, Google+, tumblr, Instagram, Yammer, LinkedIn and Twitter are widely used worldwide. Other networks have a more regional scope, e.g. Hyves is a social network used in the Netherlands, while Hi5 and Orkut are prominent in South and Central America. Other popular networks include, Badoo, Bebo, Tuenti, Cyworld, Mixi, Orkut, renren, weibo and Wretch. It should be noted that social networks can rise and disappear in the course of a few years.

Television and radio broadcasts are still the primary means by which real-time distribution of audiovisual content items, such as movies and series, occurs. Social media has not changed this, but has provided the formerly passive consumers of such content items with a means to become more active. Using social networks, viewers can actively communicate with each other while watching a program and have their interactions viewed and responded to in real time by other viewers. The use of labels such as hashtags is crucial to have a structured discussion.

Television shows currently heavily rely on on-screen messages to promote “official” hashtags for shows or events. Alternative means for agreeing upon hashtags or other labels to be used may be thought of, but all currently-used means are manual and thus prone to errors. There thus is a need in the art to provide for a method automated

### SUMMARY OF THE INVENTION

The invention provides a computer-implemented method of automatically adding an identifier related to a content item to a communication in a multi-user communication network, comprising obtaining a robust fingerprint of the content item, retrieving the identifier from a database using the robust fingerprint, and adding the identifier formatted in a format suitable for the multi-user communication network to the communication. The multi-user communication network preferably is a social network. Examples include Twitter, Instagram, Yammer, LinkedIn and Facebook.

A robust fingerprint (sometimes referred to as a robust hash) of a content item is a representation of the most relevant perceptual features of the item. In most systems using fingerprinting technology, the fingerprints of a large number of content items along with their associated respective metadata are stored in a database. The term “metadata” refers to information such as the title, artist, genre and so on for a content item. The metadata of a content item is retrieved by computing its fingerprint and performing a lookup or query in the database using the computed fingerprint as a lookup key or query parameter. The lookup then returns the metadata associated with the fingerprint. In accordance with the invention, the metadata comprises the desired identifier related to the content item for use in the social network.

Preferably the method comprises adding plural identifiers related to the content item to the communication, each of the plural identifiers being retrieved the identifier from a database using the robust fingerprint. For example, on Twitter a hashtag for the TV show and for a particular actor in the show could be included. On Facebook one might use a reference to the show's Facebook page and a hashtag for #seasonfinale if the episode in question is a season finale.

In a further embodiment the robust fingerprint relates to a particular timepoint in the content item and the identifier relates to an aspect of the content item at the particular timepoint. Robust fingerprinting relies on computing a unique code for a portion of the content item. Many fingerprinting schemes are able to relate a fingerprint to a point in time in the content item, which creates an opportunity for identifiers specifically related to that point in time. For example, an identifier to include could be #goal during a soccer match when a goal is scored or #AwesomeBMW when a James Bond movie shows a BMW model car.

In a further embodiment the step of formatting comprises adding a category-identifying label to the identifier prior to adding the identifier to the communication. In Twitter for instance, the hashtag serves as the category-identifying label.

In a further embodiment the content item is audio or video content delivered for live viewing. This type of content is more likely to be discussed on social networks than on-demand content such as DVD movies, so it is advantageous to apply the method of the invention to such content.

In a further embodiment the communication is automatically generated upon a single action by a particular user and comprises a predefined message, a reference to a title of the content item and the identifier. A single-action communication is most convenient for the user.

The invention further provides for a computer system for rendering a content item, comprising a multi-user communication means configured for automatically adding an identifier related to the content item to a communication in the multi-user communication network, the multi-user communication means being configured for causing a fingerprinting means to obtain a robust fingerprint of the content item, for causing a query means to retrieve the identifier from a database using the robust fingerprint, and for adding the identifier formatted in a format suitable for the multi-user communication network to the communication.

In an embodiment the multi-user communication means is configured to automatically generate the communication, upon a single action by a particular user, the communication comprising a predefined message, a reference to a title of the content item and the identifier.

The invention further provides for a computer-readable storage medium comprising executable code for causing a computer to operate as the system of the invention.

### BRIEF DESCRIPTION OF THE FIGURES

The invention will now be explained in more detail with reference to the figures, in which:

FIG. 1 schematically illustrates a first embodiment of the computer-implemented method of the invention, employing a rendering device and a capture device;

FIG. 2 shows the capture device in more detail;

FIG. 3 schematically shows a second embodiment of the invention, integrating the rendering and capture devices; and

FIG. 4 schematically shows a third embodiment of the invention, in which certain but not all components of the capture device are integrated with the rendering device.

In the figures, same reference numbers indicate same or similar features. In cases where plural identical features, objects or items are shown, reference numerals are provided only for a representative sample so as to not affect clarity of the figures.

### DETAILED DESCRIPTION OF CERTAIN EMBODIMENTS

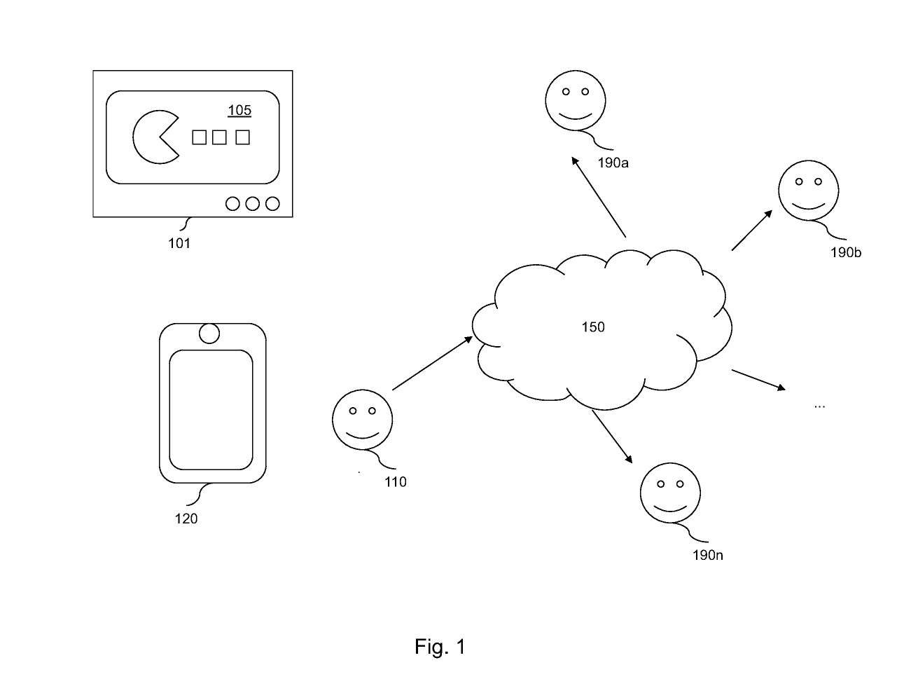

FIG. 1 schematically illustrates a first embodiment of the computer-implemented method of the invention. A rendering device 101, shown as a television but alternative rendering devices such as radios, laptops or tablets are also possible, renders a content item 105 such as a television program, movie, radio program or commercial. Preferably the content item 105 is audio or video content delivered for live viewing, e.g. a television program broadcast at a particular point in time (even if the actual program was prerecorded). This may involve internet-based live streaming but other techniques for broadcasting or narrowcasting may also be used.

A user 110 is a participant on a social network, multi-user communication network 150. The user 110 can send messages to the network 150 which are then distributed to other users 190a, 190b, . . . 190n. To facilitate the communication the user 110 employs capturing device 120, shown here as a tablet computer although it could equally well be a telephone, laptop, watch or other device which is Internet-enabled.

In accordance with the invention the device 120 allows the user to automatically add an identifier related to the content item 105 to a communication in the multi-user communication network 150. To this end, the device 120 is capable of obtaining a robust fingerprint of the content item, retrieving the identifier from a database using the robust fingerprint, and adding the identifier formatted in a format suitable for the to the communication.

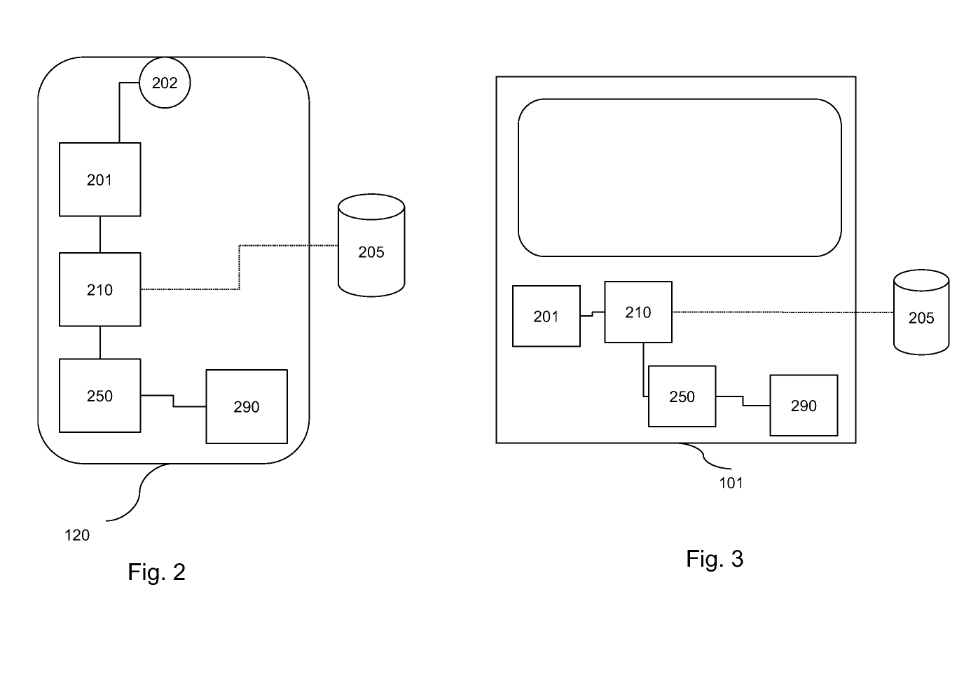

FIG. 2 shows the device 120 in more detail. A robust fingerprinting module 201 obtains a robust fingerprint of the content item, employing input module 202 such as a camera or microphone. The input module 202 would make a recording of the content item 105 as it is being rendered on the device 101, e.g. by taking a photo, recording audio or video, and supply the recording to the module 201 for the calculation of a fingerprint.

Robust fingerprinting of content as such is well-known. One example of a robust fingerprinting technology is Jaap Haitsma and Ton Kalker, ‘A Highly Robust Audio Fingerprinting System’, ISMIR 2002. In this technology, the content item is divided in successive (preferably overlapping) time intervals. For each time interval, the frequency spectrum is divided in bands. A robust property of each band (e.g. energy) is computed and represented by a respective fingerprint bit. A content item is thus represented by a fingerprint comprising a concatenation of binary values, one for each time interval.

When a content item fingerprint is computed when a portion of a certain length, typically about three seconds, has been received. This smaller fingerprint is then matched (e.g. using a sliding window technique) against the fingerprint for the complete content item. Note that one content item may have plural associated fingerprints.

The fingerprint is supplied to lookup module 210 which retrieves an identifier from a database 205 using the robust fingerprint. The database 205 here is shown as accessible external to the device 120, e.g. over a local network or the Internet. Alternatively the database 205 is stored locally in the device 120. If the database is stored locally, it is preferably updated periodically to remain as up-to-date as possible.

Instead of just one identifier, the lookup module 210 may retrieve plural identifiers from the database 205 using the robust fingerprint. Multiple databases may be employed, each with different identifiers to be retrieved, but this may incur extra delays as each database would have to be queried individually.

Usually, a robust fingerprint relates specifically to a particular timepoint in the content item 105. Well-known fingerprinting algorithms may need a few seconds of content to calculate a fingerprint that uniquely identifies the content item 105. That portion of content can then also be related time-wise to the content item 105 as a whole, allowing identification within a sub-second window as to where in the content item 105 the fingerprinting occurred.

With this information it becomes possible to have the identifier relate to an aspect of the content item 105 at the particular timepoint. For example, the identifier could relate to a person, event or object occurring at that timepoint, such as “goal” when a goal is scored in a match or “Cameo by director” if a movie's director makes a brief appearance in a movie. The metadata used for these extra identifiers may be manually entered by an operator or by analysing closed captioning, performing speech to text analysis on the audio or any other source.

Social media communication module 290 is available for communication to the social network 150. Formatting module 250 converts the identifier or identifiers retrieved by the lookup module 210 into a format suitable for the network 150. Preferably this includes adding a category-identifying label to the identifier. For example, on Twitter, the formatting module 250 could add a hashtag (#) to the identifier. In addition, formatting could include removing spaces or other disallowed characters, or shortening the identifier based on rules set by operators of the network 150. In the above example the identifier “Cameo by director” would become #cameobydirector on Twitter.

The identifier in its formatted form is then supplied to the social media communication module 290 where it can be incorporated into a message to be sent out. This may be done manually, e.g. by having the formatting module 250 display or audibly render the identifier, or automatically, e.g. by having the formatting module 250 prepare a message including the formatted identifier. Many social media communication modules 290, e.g. Twitter or Facebook client applications, comprise readily-available functionality for automatically creating messages based on input generated by other applications.

Preferably the communication is automatically generated upon a single action by the user 110 and comprises a predefined message, a reference to a title of the content item 105 and the identifier. The predefined message could be e.g. “Now watching”, “Now on TV” or “At home, watching” or any other message preprogrammed or selected by the user 110 or by a third party. A complete communication could then e.g. become “Now watching Skyfall #jamesbond” if the content item 105 is the James Bond movie titled ‘Skyfall’. Plural identifiers could be added and/or the identifier(s) could be time-related, e.g. “Now watching #finalbattle of Skyfall #jamesbond”.

FIG. 3 schematically shows a second embodiment of the invention, integrating devices 101 and 120. In this embodiment, the device 101 comprises robust fingerprinting module 201, lookup module 210 and database 205, formatting module 250 and social media communication module 290.

Input module 202 such as a camera or microphone is no longer necessary as device 120 by its nature already has access to the content item 105, and thus can obtain of a fingerprint without having to separately capture input. As with FIG. 2, database 205 is provided external to the device 101 but may also be provided internal to the device.

The resulting computer system shown in FIG. 3 essentially does away with the need to possess a device like device 120, requiring only that the device 101 is capable of communicating with the network 150. An Internet-enabled television with the capability of installing custom software or apps would be sufficient; modules 201, 210, 205, 250 and 290 can be provided as a custom application to be downloaded into the device 101.

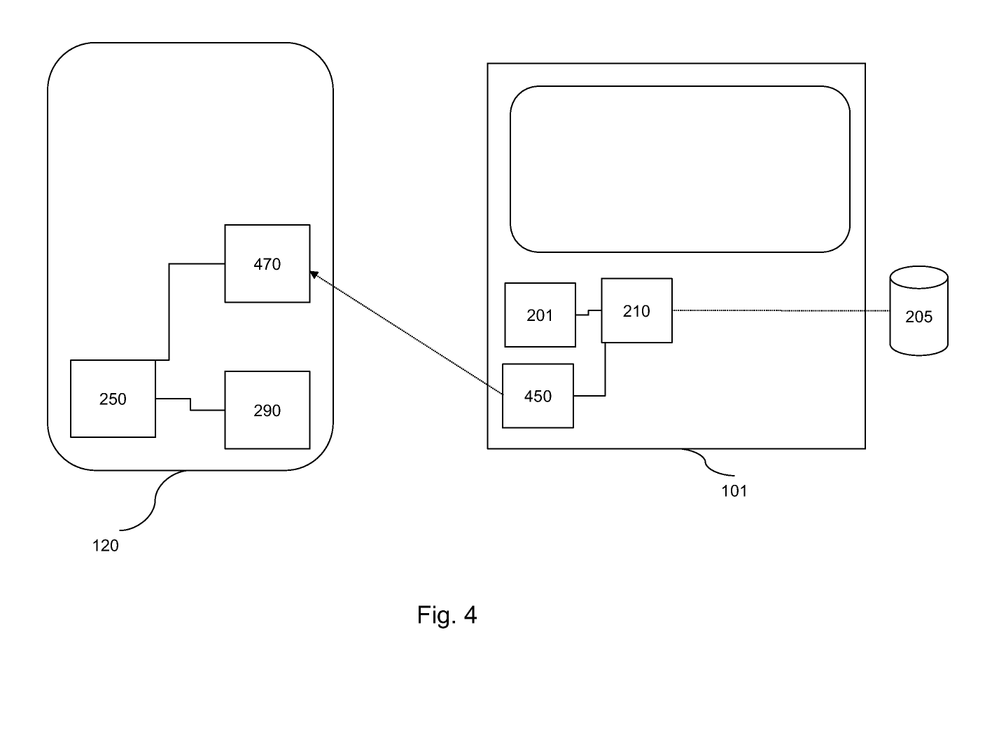

FIG. 4 schematically shows a third embodiment of the invention, in which certain but not all components of the device 120 are integrated with the device 101. Device 101 comprises robust fingerprinting module 201, lookup module 210 and database 205, while device 120 comprises formatting module 250 and social media communication module 290. As with FIG. 2, database 205 is provided external to the device 101 but may also be provided internal to the device 101. Further, formatting module 250 could also be provided in device 120.

New are communication module 450 in device 101 and communication module 470 in device 120. These modules work together to transfer the identifier (or identifiers) obtained by lookup module 210 to the device 120 where the same may be incorporated into a communication to be sent out using module 290 to the social network 150. Technology for such transmission includes Bluetooth, infrared and IEEE 802.11 (wifi) connections. This embodiment of the invention has the advantage that no input module 202 is necessary and that the relatively complex operation of fingerprinting can be provided in a high-capacity device like a digital television rather than a low-capacity device such as a phone, watch or glasses (e.g. the Google Glasses product recently available from Google, Inc).

For convenience, the already-mentioned single-action initiation by the user 110 is preferably added in this embodiment. This single action causes the communication to be automatically generated, which communication comprises a predefined message, a reference to a title of the content item 105 and the identifier. A button or similar input element to initiate the single action may be provided either in the device 101 or in the device 120. If provided in the device 120, the communication module 470 may need to be adapted to send a message to communication module 450 in device 101 to activate the robust fingerprinting module 201.

### CLOSING NOTES

The above provides a description of several useful embodiments that serve to illustrate and describe the invention. The description is not intended to be an exhaustive description of all possible ways in which the invention can be implemented or used. The skilled person will be able to think of many modifications and variations that still rely on the essential features of the invention as presented in the claims. In addition, well-known methods, procedures, components, and circuits have not been described in detail.

Some or all aspects of the invention may be implemented in a computer program product, i.e. a collection of computer program instructions stored on a computer readable storage device for execution by a computer. The instructions of the present invention may be in any interpretable or executable code mechanism, including but not limited to scripts, interpretable programs, dynamic link libraries (DLLs) or Java classes. The instructions can be provided as complete executable programs, as modifications to existing programs or extensions (“plugins”) for existing programs. Moreover, parts of the processing of the present invention may be distributed over multiple computers or processors for better performance, reliability, and/or cost.

Storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. Transmission of the computer program product by e-mail is of course also possible.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

1. A computer-implemented method of automatically adding an identifier related to a content item to a communication in a multi-user communication network, comprising obtaining a robust fingerprint of the content item, retrieving the identifier from a database using the robust fingerprint, and adding the identifier formatted in a format suitable for the multi-user communication network to the communication.

2. The method of claim 1, comprising adding plural identifiers related to the content item to the communication, each of the plural identifiers being retrieved the identifier from a database using the robust fingerprint.

3. The method of claim 1, where the multi-user communication network is a social network.

4. The method of claim 1, in which the robust fingerprint relates to a particular timepoint in the content item and the identifier relates to an aspect of the content item at the particular timepoint.

5. The method of claim 1, where the step of formatting comprises adding a category-identifying label to the identifier prior to adding the identifier to the communication.

6. The method of claim 1, in which the content item is audio or video content delivered for live viewing.

7. The method of claim 1, in which the communication is automatically generated upon a single action by a particular user and comprises a predefined message, a reference to a title of the content item and the identifier.

8. A computer system for rendering a content item, comprising a multi-user communication means configured for automatically adding an identifier related to the content item to a communication in the multi-user communication network, the multi-user communication means being configured for causing a fingerprinting means to obtain a robust fingerprint of the content item, for causing a query means to retrieve the identifier from a database using the robust fingerprint, and for adding the identifier formatted in a format suitable for the multi-user communication network to the communication.

9. The computer system of claim 8, in which the multi-user communication means is configured to automatically generate the communication, upon a single action by a particular user, the communication comprising a predefined message, a reference to a title of the content item and the identifier.

10. A computer-readable storage medium comprising executable code for causing a computer to perform the method of claim 1.
